(19) United States
(12) Patent Application Publication
(10) Pub. No.: US 2025/0315070 A1
(43) Pub. Date: Oct. 9, 2025

(54) DYNAMIC FREQUENCY DOMAIN ANALYSIS-BASED POWER ADAPTATION FOR CHANGING OPERATING CONDITIONS

(71) Applicant: Google LLC, Mountain View, CA (US)

(72) Inventors: Xiaohu Zhou, Sunnyvale, CA (US); Dayu Qu, Cupertino, CA (US)

(73) Assignee: Google LLC, Mountain View, CA (US)

(21) Appl. No.: 19/170,501

(22) Filed: Apr. 4, 2025

Related U.S. Application Data
(60) Provisional application No. 63/574,643, filed on Apr. 4, 2024.

(51) Int. Cl. G05F 1/573; G05F 1/46

(52) U.S. Cl. CPC G05F 1/573; G05F 1/462

(57) ABSTRACT

Systems and methods are described for applying one or more frequency domain analyses to AC components to automatically discriminate between different operating conditions of the power architecture. Embodiments can then adaptively adjust the voltage (e.g., and current) to reduce or eliminate extra power consumption based on the detected operating condition. In some embodiments, the frequency domain analyses are based on fast Fourier transform (FFT) techniques and/or total harmonic distortion (THD) techniques. Embodiments can be applied to internal power modules and/or to external power adapters.

### CROSS REFERENCE TO RELATED APPLICATION

This application claims the benefit of, and priority to U.S. Provisional Application No. 63/574,643, filed on Apr. 4, 2024, which is hereby incorporated by reference in its entirety for all purposes.

### TECHNICAL FIELD

This disclosure generally relates to power adaptation for electronic devices and particularly to dynamic frequency domain analysis-based power adaptation for changing operating conditions.

### BACKGROUND

Some consumer electronic products operate in different modes that have correspondingly different power requirements. For example, a docking station can have certain power requirements for interfacing with processor regulators and/or other low-power features, for charging tablets and/or other intermediate-power features, for driving power amplifiers and/or other high-power features, etc. Conventionally, a power system provides sufficient power to support the highest power requirements, even when the higher power features are inactive. This can yield inefficiencies and other undesirable effects, including sub-optimal power consumption and related negative impacts to a product's thermal throttling, user experience, cost, etc.

### BRIEF SUMMARY

Certain embodiments of the present disclosure relate generally to power adaptation for electronic devices and particularly to dynamic frequency domain analysis-based power adaptation for changing operating conditions.

Systems and methods are described for applying one or more frequency domain analyses to AC components to automatically discriminate between different operating conditions of the power architecture. Embodiments can then adaptively adjust the voltage (e.g., and current) to reduce or eliminate extra power consumption based at least in part on the detected operating condition. In some embodiments, the frequency domain analyses are based at least in part on fast Fourier transform (FFT) techniques and/or total harmonic distortion (THD) techniques. Embodiments can be applied to internal power modules and/or to external power adapters.

In one aspect, a system may control power to an electronic device with operating condition-aware power adaptation. The system may include one or a combination of the following. A power supply subsystem may be configured to output power to drive an electronic device, the power supply subsystem to drive the electronic device with a source voltage signal corresponding to a first output voltage. A frequency domain analyzer may be coupled with the power supply subsystem to receive the source voltage signal that is provided to the electronic device, the frequency domain analyzer to output spectral content information characterizing the source voltage signal. A discriminator may be coupled with the frequency domain analyzer and the power supply subsystem. The discriminator may determine, based at least in part on the spectral content information, an operating condition corresponding to the electronic device being driven by the source voltage signal. The discriminator may generate a control signal as a function of the determined operating condition to implement adaptive voltage control. The operating condition may be selected from a group comprising an idle mode, a charging mode, and an audio mode. The adaptive voltage control may include the power supply subsystem optimizing the source voltage signal. The optimizing may include adjusting the source voltage signal to a second output voltage. The second output voltage may be different from the first output voltage. The second output voltage may be optimized for the determined operating condition in which the electronic is determined to be operating.

In another aspect, method may control power to an electronic device with operating condition-aware power adaptation. The method may include one or a combination of the following. Power may be output to drive an electronic device with a source voltage signal corresponding to a first output voltage. The source voltage signal that is provided to the electronic device may be received. Spectral content information characterizing the source voltage signal may be output. An operating condition corresponding to the electronic device being driven by the source voltage signal may be determined based at least in part on the spectral content information. The operating condition may be selected from a group including an idle mode, a charging mode, and an audio mode. A control signal may be generated as a function of the determined operating condition to implement adaptive voltage control. Implementing adaptive voltage control may include optimizing the source voltage signal. The optimizing may include adjusting the source voltage signal to a second output voltage that is different from the first output voltage. The second output voltage may be optimized for the determined operating condition in which the electronic is determined to be operating.

In various embodiments, when the operating condition corresponding to the electronic device is determined to be the idle mode, the second output voltage may be adjusted to a lower voltage that is lower than the first output voltage. The adaptive voltage control may further include causing the adjusted source voltage signal to bypass an intermediate bus voltage regulator that is coupled with the power supply subsystem while driving the electronic device in the idle mode.

In various embodiments, when the operating condition corresponding to the electronic device is determined to be the charging mode, the second output voltage may be adjusted to an intermediate voltage that is between a minimum voltage and a maximum voltage. The adaptive voltage control may further include causing the adjusted source voltage signal to bypass a charging bus voltage regulator that is coupled with the power supply subsystem while driving the electronic device in the charging mode. The generating the control signal as a function of the determined operating condition may be further to implement adaptive current control. The adaptive current control may include the power supply subsystem controlling a current driving the electronic device to regulate the output current within its max allowable power and prevent the electronic device from brown-out caused by overcharging. The controlling the current is in accordance with a droop current control profile.

In various embodiments, when the operating condition corresponding to the electronic device is determined to be the audio mode, the second output voltage may be adjusted to a higher voltage that is higher than the first output voltage. The second output voltage may correspond to a maximum voltage. The generating the control signal as a function of the determined operating condition may be further to implement adaptive current control. The adaptive current control may include the power supply subsystem controlling a current driving the electronic device to regulate the output current within its max allowable power and prevent the electronic device from brown-out caused by audio peak power. The controlling the current may be in accordance with a droop current control profile.

In various embodiments, a power optimizer of the power supply subsystem may be condition-aware and may be coupled with the discriminator to generate the optimized source voltage signal based at least in part on the control signal and the source voltage signal. In various embodiments, a power supply block of the power supply subsystem may be configured to generate the optimized source voltage signal based at least in part on the control signal. In various embodiments, the power supply subsystem may include a power supply block coupled with a power sense block. The frequency domain analyzer may be coupled with an output of the power sense block to receive the source voltage signal.

In various embodiments, the system may correspond to an internal power supply of the electronic device. In various embodiments, the system may correspond to an external power supply of the electronic device. In various embodiments, the system is configured to simultaneously drive a plurality of electronic devices with the adaptive voltage control and the adaptive current control. The adaptive voltage control may include the power supply subsystem optimizing a plurality of source voltage signals based at least in part on different operating conditions for the plurality of electronic devices when one or more electronic devices of the plurality of electronic devices is in one of the idle mode, the charging mode, or the audio mode while one or more other electronic devices of the plurality of electronic devices is in a different one of the idle mode, the charging mode, or the audio mode. The adaptive current control may include the power supply subsystem controlling a plurality of currents to regulate output currents within one or more maximum allowable power values based at least in part on the different operating conditions for the plurality of electronic devices when one or more electronic devices of the plurality of electronic devices is in one of the idle mode, the charging mode, or the audio mode while one or more other electronic devices of the plurality of electronic devices is in a different one of the idle mode, the charging mode, or the audio mode.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure. The frequency domain analyzer may output the spectral content information characterizing the source voltage signal based at least in part on a fast Fourier transform analysis of the source voltage signal. In various embodiments, the frequency domain analyzer may output the spectral content information characterizing the source voltage signal based at least in part on total harmonic distortion analysis of the source voltage signal.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an illustrative power architecture of a tablet docking station.

FIGS. 2A and 2B show block diagrams of illustrative operating condition-adaptive power architectures, according to embodiments described herein.

FIG. 3 shows a block diagram of an illustrative operating condition-adaptive power architecture based at least in part on frequency transformation, according to some embodiments described herein.

FIGS. 4A-4C show example plots of AC components with different spectral content that is characteristic of three different operating conditions.

FIG. 5 shows a block diagram of an illustrative operating condition-adaptive power architecture based at least in part on total harmonic distortion, according to some embodiments described herein.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Disclosed embodiments may provide for applying one or more frequency domain analyses to AC components to automatically discriminate between different operating conditions of the power architecture. Embodiments can then adaptively adjust the voltage (e.g., and current) to reduce or eliminate extra power consumption based at least in part on the detected operating condition. In some embodiments, the frequency domain analyses are based at least in part on fast Fourier transform (FFT) techniques and/or total harmonic distortion (THD) techniques. Embodiments can be applied to internal power modules and/or to external power adapters.

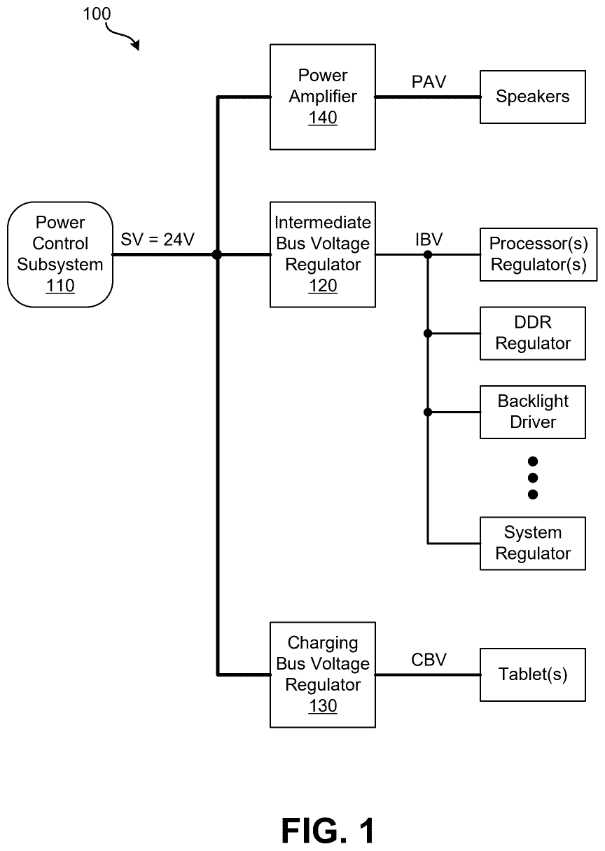

Various embodiments will now be discussed in greater detail with reference to the accompanying figures, beginning with FIG. 1.

FIG. 1 shows an illustrative power architecture 100 of a tablet docking station. The power architecture 100 can similarly apply to other products, such as a smart speaker, a doorbell device, or any other consumer electronic product in which multiple operating modes yield significantly different power requirements, as described herein. As illustrated, the power architecture 100 incudes a power control subsystem 110 (which may also be referenced as a power supply subsystem 110) that provides a voltage- and current-controlled power signal to a power bus 115. The tablet docking station is configured to support different components (e.g., internal to the docking station and plugged into the docking station), and those different components tend to have different input power requirements. Typically, the power signal on the power bus 115 is generated by the power control subsystem 110 to have sufficient voltage and current to support the components with the highest power requirements.

For example, in the illustrated architecture 100, the power control system 110 outputs a source voltage (SV) signal, such as a 24-volt power signal. A first group of components uses an intermediate bus voltage (IBV), such as 5-volt input power; a second group of components uses a charging bus voltage (CBV), such as 12-volt input power; and a third group of components uses a power amplifier output voltage (PAV). The first group can include processor regulators (e.g., a CPU regulator, GPU regulator, etc.), a DDR regulator, a backlight driver, a system regulator, etc.). An intermediate bus voltage regulator (IBVR) 120 can convert the power bus 115 signal to the IBV signal for input to the first group of components. The second group can include tablet computers and/or other similar components that use the docking station for charging and powering. A charging bus voltage regulator (CBVR) 130 can convert the power bus 115 signal to the CBV signal for input to the second group of components. The third group can include speakers and/or other similar components that use the docking station to drive a power amplifier with high dynamic range. A power amplifier (PA) 140 (e.g., a high-voltage audio amplifier) can amplify the power bus 115 signal to drive the third group of components with the PAV.

In various embodiments, the architecture 100 may be coupled with, and configured to drive, a set of one or more electronic devices from one or more of the groups with all of the PAV, IBV, and CBV. Accordingly, the power control subsystem 110 may be configured to drive a single electronic device with the PAV, IBV, and CBV and/or a plurality of electronic devices, which may be the same types of devices or may include a variety of different devices from different groups. In various embodiments, the power control subsystem 110 may include the power amplifier 140, intermediate bus voltage regulator 120, and/or charging bus voltage regulator 130. In various embodiments, the power control subsystem 110 may not include, but may be coupled with, the power amplifier 140, intermediate bus voltage regulator 120, and/or charging bus voltage regulator 130.

Satisfying different power requirements continuously and concurrently can cause inefficiencies and other undesirable effects. For example, a high DC voltage is preferable for powering the power amplifier 140 when a high dynamic range is desired, such as for audio applications; but using the same high DC voltage to power the lower-voltage (e.g., first group) components can effectively cause higher overall power consumption (those components run more efficiently with lower DC voltages). The higher power consumption can also adversely affect the product's thermal throttling, user experience, cost, etc. Notably, audio is not always running, a laptop may not always be charging, etc., such that the added power consumption may not even be providing any benefit during those times.

Embodiments described herein apply one or more frequency domain analyses to AC components to automatically discriminate between different operating conditions of the power architecture. Embodiments can then adaptively adjust the voltage (e.g., and current) to reduce or eliminate extra power consumption based at least in part on the detected operating condition. In some embodiments, the frequency domain analyses are based at least in part on fast Fourier transform (FFT) techniques and/or total harmonic distortion (THD) techniques. Adaptively adjusting the power signal based at least in part on the detected operating condition can provide several features, including benefitting the product's thermal design, mechanical design, cost, and/or environmental sustainability. Embodiments can be applied to internal power modules and/or to external power adapters.

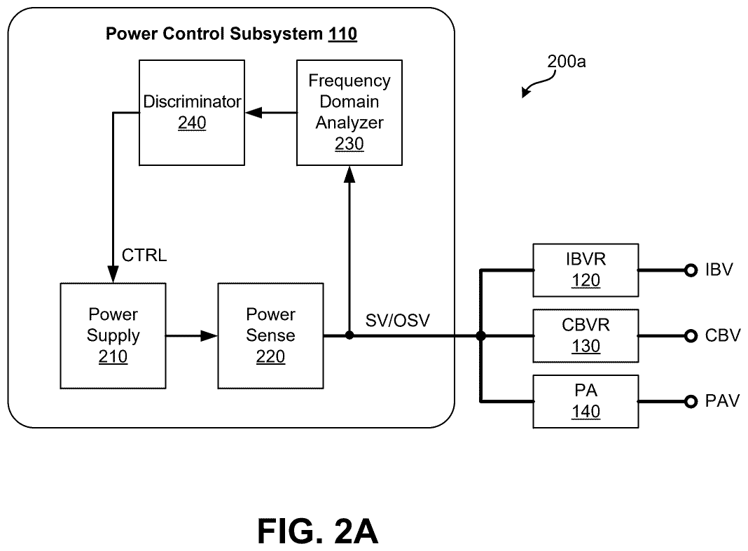

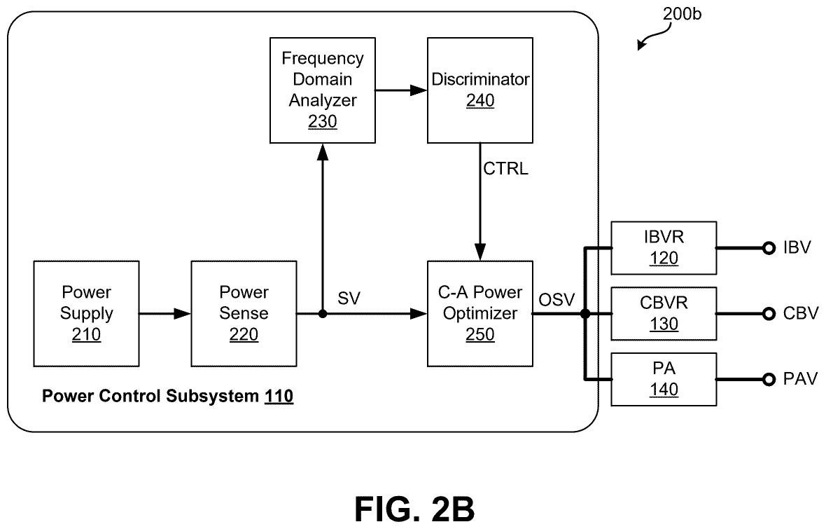

FIGS. 2A and 2B show block diagrams of illustrative operating condition-adaptive power architectures 200, according to embodiments described herein. Both illustrated power architectures 200 can include a power supply block 210, a power sense block 220, a frequency domain analyzer 230, and a discriminator 240. The power supply block 210 can include a wall plug for receiving line power, a converter, a battery, and/or any other suitable component for receiving and/or generating a supply power signal. The power sense block 220 generally monitors and manages delivery of the supply power signal to the downstream components (i.e., the load). Embodiments of the power sense block 220 can perform several functions, including measuring and/or monitoring the voltage and current being supplied to the load, evaluating the quality of power being supplied (e.g., including evaluating stability, noise, etc.), providing power protection features (e.g., overvoltage protection, undervoltage protection, overcurrent protection, short circuit protection, etc.), etc. The power sense block 220 can be implemented as a dedicated circuit or module, integrated with the power supply block 210, and/or in any feasible manner. The output of the power sense block 220 can be used as the source power signal driving the power bus 115 of FIG. 1.

As illustrated in FIG. 1, different types of components can be electrically coupled with the source power signal (e.g., via the power bus 115). Depending on the presence of those components, whether and how they are operating, etc., the spectral content of the source power signal can be appreciably impacted. One type of impact is from harmonic generation. For example, electronic components and devices that operate with non-linear characteristics (e.g., rectifiers, switching power supplies, variable frequency drives, etc.) can introduce harmonics into the power system, which can distort the waveform of the source power signal. As described herein, harmonics are frequencies that are integer multiples of a fundamental power frequency. A related type of impact is from intermodulation distortion. For example, when multiple frequencies (fundamental and harmonics) are present on the power bus, they can interact through non-linear devices, creating additional frequencies that are sums and differences of the original frequencies.

Another type of impact is from load switching and transients. For example, loads that frequently switch on and off (e.g., motors, compressors, switching power supplies, etc.) create transient spikes and dips in the power bus, which can have broad spectral content due to their sudden nature. In general, components that introduce harmonics, intermodulation distortion, transients, or the like tend to do so by drawing power in a non-linear or time-varying manner. Such non-linear consumption can cause fluctuations and distortions that may not be confined to the device itself but may reflect back into the power bus propagate along the bus to affect the source power signal as seen by other connected components.

Another type of impact is from resonance. For example, the power system (e.g., including the power bus and connected loads) can have resonant frequencies that become amplified due to inductive and capacitive characteristics of the system, which can create appreciable voltage and current distortions at those frequencies. Another type of impact is from impedance variation. For example, different components can have different impedances, which can vary with frequency, and the total impedance seen by the power source can change depending on which loads are connected and their operational state. Another type of impact is from phase shifts. For example, inductive and/or capacitive loads can induce phase shifts between voltage and current, which can affect the phase angle of the power signal and influence interactions between harmonics and the fundamental frequency.

Due to the above and/or other types of impacts, different operating conditions of a docking station, smart speaker, doorbell device, or other similar type of product can manifest as appreciable differences in frequency domain (e.g., AC) characteristics of the source power signal at the output of the power sense block 220. As illustrated, embodiments of the frequency domain analyzer 230 are coupled with the output of the power sense block 220 to perform “frequency domain analysis” on the source voltage signal. The frequency domain analyzer 230 can perform any suitable type of frequency domain analysis that provides suitable information for discriminating among AC performance in those different operating conditions. The term “frequency domain analysis” as used herein broadly includes both the analysis of a signal's frequency components (e.g., spectral content) and the manner in which those components (i.e., frequency domain representations) are extracted and utilized to support features described herein. Terms, like “frequency domain content,” “spectral content,” and the like are used interchangeably.

Embodiments of the frequency domain analyzer 230 can be implemented using any suitable analog and/or digital components. As described herein, some implementations of the frequency domain analyzer 230 perform a frequency domain analysis based at least in part on transforming time-domain signals into frequency-domain representations to reveal discriminating characteristics. Examples of such transformation techniques include using a fast Fourier transform (FFT), an inverse FFT (iFFT), a short-time FFT (STFT), a wavelet transform, a discrete cosine transform (DCT), a discrete wavelet transform (DWT), a Hilbert transform, a Z-transform, a chirp Z-transform, etc. Some implementations of the frequency domain analyzer 230 perform a frequency domain analysis based at least in part on spectral estimation, cross-spectral analysis, autoregressive (AR) modeling, or the like. Some implementations of the frequency domain analyzer 230 perform a frequency domain analysis based at least in part on approaches relating to total harmonic distortion (THD). Examples of such techniques include THD analysis, THD-plus-Noise (THD+N) analysis, intermodulation distortion (IMD) analysis, harmonic analysis, signal-to-noise and distortion ratio (SINAD) analysis, etc.

Embodiments of the frequency domain analyzer 230 use any of the above and/or other feasible techniques to output frequency domain information (e.g., spectral content) of the source power signal. Embodiments of the discriminator 240 include any suitable components for mapping the frequency domain information to one of a discrete set of two or more pre-classified operating conditions. In some embodiments, the operating conditions include an “idle” (or “sleep,” “standby,” etc.) condition in which most function blocks are not active. For example, in such a condition, connected display components are off, connected audio components are off, etc. (e.g., only occupancy and presence detection are enabled). In the idle mode, power consumption tends to be low (e.g., less than 1000 milliwatts). Further, DC components tend to be low, while AC components tend to be above the 20 KHz range (e.g., because related semiconductor switching is typically designed to be above the audible range to avoid acoustic noise).

In some embodiments, additionally or alternatively, the operating conditions include a “charging” mode in which the system is being used to charge tablets and/or other connected components with constant high power. In such a charging mode, the system power consumption and power conversion loss tend to be high. For example, power conversion loss while fast charging a tablet can be approximately 625 milliwatts, which can account for over ten percent of a docking station's thermal envelope. Further, in the charging condition, the power is mainly DC power, and AC components tend to be in the power semiconductors' normal switching frequency range (e.g., approximately 60 kHz-100 kHz).

In some embodiments, additionally or alternatively, the operating conditions include an “audio active” condition in which a high-power audio amplifier is actively amplifying the source power signal to power speakers, or the like. In this condition, the peak power tends to be appreciably higher than (i.e., the highest) in comparison to the other operating conditions. Further, in the “audio active” condition, the power tends to be primarily AC pulsating power with AC components in the audible range (e.g., approximately 20 Hz-20 kHz).

In one implementation, the discriminator 240 is configured to discriminate between three conditions: an idle mode, a charging mode, and an audio active mode. In another implementation, the discriminator 240 is configured to discriminate between two conditions: audio active and “audio inactive” condition (i.e., not audio active). For example, such embodiments optimize the power based at least in part on whether or not the audio system (e.g., or display system, or other system driven by a power amplifier) is presently active.

In another implementation, the discriminator 240 is configured to discriminate between two conditions: higher power (e.g., encompassing at least the charging and audio active conditions) and lower power (e.g., encompassing at least the idle condition). For instance, such embodiments optimize power based at least in part on whether or not the product is idle. As one example, a smart home hub (e.g., a smart speaker) includes a speaker, display, charge ports, sensors, etc. Most of the time, the hub just sits inactive waiting to detect user presence, an audio command, etc. During those times, the hub is in idle mode, whereby the speaker system is inactive, the display is inactive, etc., but sensors and other components are still active. When user presence, an audio command, or some other trigger is detected, the hub can exit idle mode (e.g., the display turns on, the speaker system becomes active, etc.). Depending on the types and diversities of components and component states, there may be more and/or different operating conditions with different characteristic spectral content.

Embodiments of the discriminator 240 include different types of components discriminating among different types of frequency domain information. In some embodiments, the discriminator 240 includes voltage level detection components to discriminate among different operating conditions at least partially based on AC voltage levels (e.g., peak, RMS, etc.). In some embodiments, the discriminator 240 includes components to discriminate among different operating conditions at least partially based on frequency ranges (e.g., using bandpass filters, frequency bins, etc.). In some embodiments, the discriminator 240 includes classifier networks, and/or other trained networks (e.g., trained neural networks, such as convolutional neural networks) to discriminate among different operating conditions at least partially based on frequency domain patterns (e.g., envelopes, time variance, etc.). The output of the discriminator 240 is a control signal (“CTRL”) that corresponds to the detected operating condition(s).

Referring specifically to FIG. 2A, a first architecture 200a is shown in which the CTRL output of the discriminator 240 is fed back as a control signal for the power supply 210. In such an architecture, the power supply 210 is directly controlled to output an optimized source voltage signal (OSV) based at least in part on the detected operating condition(s). Referring to FIG. 1, the bus voltage 115 can be the OSV. For example, if the product incorporating this architecture 200a is in an idle mode, the frequency domain analyzer 230 can generate spectral content information from the supply voltage signal at the output of the power sense block 220. The discriminator 240 can use the spectral content information to detect the idle condition and can output a corresponding control signal. The control signal can direct the power supply 210 to output the OSV to support only the power requirements of the idle condition, such as the IBV.

Turning to FIG. 2B, a second architecture 200b is shown in which the CTRL output of the discriminator 240 is fed as a control signal for a condition aware (C-A) power optimizer 250. In such an architecture 200b, the power supply 210 outputs an SV signal (e.g., 24 volts) via the power sense block 220, and the SV is fed into the C-A power optimizer 250. As in FIG. 2A, the SV at the output of the power sense block 220 is also fed to the frequency domain analyzer 230 to generate spectral content information, and the discriminator 240 can use the spectral content information to detect the operating condition(s) and to output a corresponding control signal. The C-A power optimizer 250 generates an OSV as a function of the SV and at least the control signal, so that the OSV is optimized to the presently detected operating condition(s). For example, the C-A power optimizer 250 can include one or more voltage dividers, power converters (e.g., DC-DC converters, AC-DC rectifiers, DC-AC inverters, AC-AC converters, etc.), regulators (e.g., linear regulators, switching regulators, etc.), filtering components (capacitors, inductors, etc.), control circuits (e.g., microcontrollers, digital signal processors, sensors, transducers, feedback loops, etc.), power management integrated circuits (PMICs), envelope trackers, machine learning blocks (e.g., neural networks), and/or any other feasible component(s) for outputting a dynamically optimized voltage.

In some implementations, the OSV generated by either architecture 200 of FIG. 2A or 2B is selected from a predetermined set of two or more voltage levels according to the control signal. For example, the OSV is generated to be one of 5 volts, 12 volts, or 24 volts, depending on the detected operating condition(s). In other implementations, the OSV can be generated as any voltage determined to be optimal for the present detected operating condition (e.g., 10 volts, 7.2 volts, etc.).

In some embodiments, a threshold change in spectral content triggers a changed operating condition event in the discriminator 240, which triggers generation (or updating) of the control signal. In such embodiments, the OSV remains at a substantially constant voltage level (or within a predetermined range) until a next detected changed operating condition event. In other embodiments, the OSV is dynamic, such that it continuously updates in response to dynamic changes in spectral content of the SV and/or OSV.

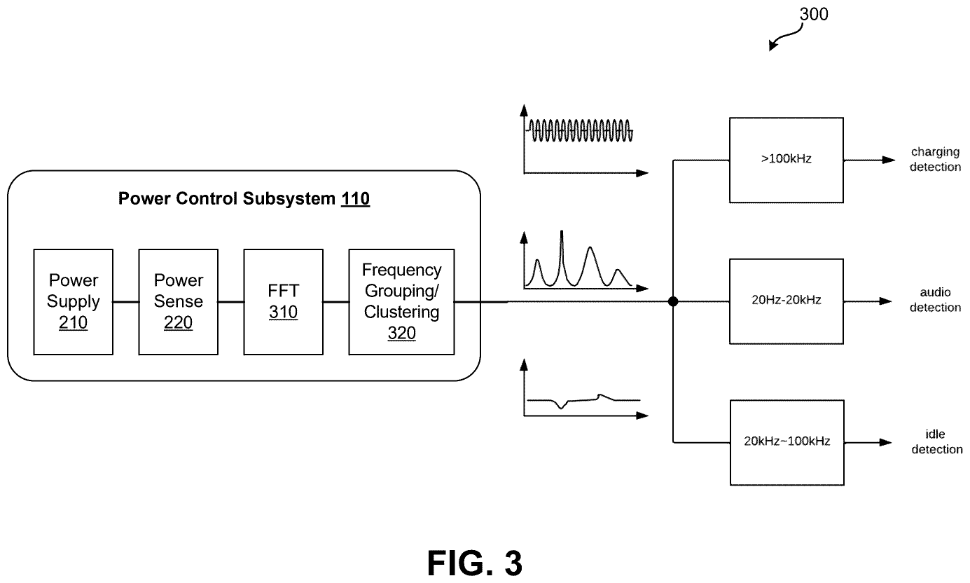

Two approaches are described in detail for implementing the frequency domain analyzer 230 and discriminator 240. FIG. 3 shows a block diagram of an illustrative operating condition-adaptive power architecture 300 based at least in part on frequency transformation, according to some embodiments described herein. As in FIGS. 2A and 2B, the architecture 300 can include a power supply block 210 and a power sense block 220 (the adaptive control path, whether as feedback to the power supply block 210 or as including the C-A power optimizer 250, is not shown). As illustrated, the frequency domain analyzer 230 of FIGS. 2A and 2B is implemented in FIG. 3 as a fast Fourier transform FFT block 310, and the discriminator 240 of FIGS. 2A and 2B is implemented in FIG. 3 as a frequency grouping and clustering block 320. Although embodiments are described with specific reference to FFT, such embodiments can be similarly implemented using other frequency transform approaches, such as those listed above.

FFT is generally an algorithm that computes a discrete Fourier transform (DFT) of a sequence, or its inverse (iDFT). Such a transform can be used to acquire, parse, and cluster spectral content into frequency ranges for discrimination. Fourier analyses convert a signal from its original domain (e.g., time or space) to a representation in the frequency domain, as follows:

$${X}_{k} = {\sum }_{m = 0}^{n - 1} {x}_{m} {e}^{- i 2 π km / n} k = 0 , … , n - 1$$

In the above equation, x₀, x₁, . . . , xₙ₋₁ are complex numbers, and e^{-2π/n} is the primitive nth root of 1. Embodiments of the FFT block 310 can perform an analysis based at least in part on the above equation, or something similar to or derived therefrom to output a frequency-domain representation of the source power signal (e.g., at the output of the voltage sense block 220). The frequency-domain representation can include a set of frequency components with respective frequencies and amplitudes.

Embodiments of the frequency grouping and clustering block 320 can discriminate according to pre-characterized mappings between frequency-domain characteristics output by the FFT block 310 and a set of two or more operating conditions. For example, if the sensed power signals are composed primarily of low-gain DC components and high-frequency AC components (e.g., above 20 kHz), this may be characteristic of the product operating in the idle condition. If the sensed power signals are composed primarily of high-gain DC components and high-frequency AC components (e.g., above 100 kHz), this may be characteristic of the product operating in the charging condition. If the sensed power signals are composed primarily of high-gain, audio-range-frequency AC components (e.g., 20 Hz-20 kHz), this may be characteristic of the product operating in the audio active condition. The conditions may not be mutually exclusive. For example, the product may be concurrently playing audio and charging one or more tablets. In such cases, the frequency grouping and clustering block 320 may detect multiple concurrent operating conditions. As such, embodiments can be designed to ensure that different operating conditions are suitably differentiable to enable accurate discrimination and/or accurate concurrent detection.

Accordingly, embodiments disclosed herein may correspond to a system to control power to an electronic device with operating condition-aware power adaptation. The system may include one or a combination of the architectures disclosed herein. The system may use intelligent detection methods and adaptive voltage and current control to reduce products power consumption. The adaptive voltage and current control may synthesize detection methods as disclosed herein. The system may be used for either an internal power module or an external power adapter. Conventional power apparatuses do not have this intelligence. The system does not rely on command from an electronic device powered by the system to change the voltage and current. The system may be decoupled from the electronic device design. Multiple electronic products and generations of electronic products can be powered by the system without any compatibility issue.

Thus, for example, the frequency domain analyzer 230 may receive the source voltage signal that is provided to the electronic device. The frequency domain analyzer 230 may output spectral content information characterizing the source voltage signal. Based at least in part on the spectral content information, the discriminator 240 may determine, an operating condition corresponding to the electronic device being driven by the source voltage signal. The operating condition may be determined be an idle mode, a charging mode, or an audio mode. The adaptive voltage control may include the power control subsystem (power supply subsystem) 110 optimizing the source voltage signal. When the electronic device is determined to be currently operating in the idle mode, the system may adaptively adjust the output voltage to a lower voltage (e.g., 5 V) and bypass the IBVR 120. This may, for example, save over 100 mW of power.

When the electronic device is determined to be currently operating in the charging mode, the system may adaptively adjust the output voltage to an intermediate voltage (e.g., 12 V) and bypass the CBVR 130 stage. This may, for example, save over 625 mW of power. Moreover, the discriminator 240 generating the control signal as a function of the determined charging mode may be further to implement adaptive current control. The adaptive current control may include the power supply subsystem 110 controlling a current driving the electronic device in accordance with a droop current control profile to regulate the output current within its max allowable power. This may include adaptively controlling the current in a positive drooping way that regulates the output current within its maximum allowable power, and this may prevent the electronic device from brown-out caused by overcharging.

When the electronic device is determined to be currently operating in the audio mode, the system may adaptively adjust the output voltage to a voltage to meet audio power requirements (e.g., a maximum voltage of 24 V). Moreover, the discriminator 240 generating the control signal as a function of the determined audio mode may be further to implement adaptive current control. This may include the power supply subsystem 110 adaptively controlling the current driving the electronic device in a droop way to regulate the output current within its maximum allowable power and prevent the electronic device from brown-out of the electronic device (e.g., a speaker of the electronic device) caused by audio peak power.

Moreover, it should be understood that the system may be configured to simultaneously drive a plurality of electronic devices with the adaptive voltage control and the adaptive current control when different electronic devices of the plurality of electronic devices are in different operating conditions. The adaptive voltage control may include the power supply subsystem 110 optimizing a plurality of source voltage signals based at least in part on different operating conditions for the plurality of electronic devices when one or more electronic devices of the plurality of electronic devices is in one of the idle mode, the charging mode, or the audio mode while one or more other electronic devices of the plurality of electronic devices is in a different one of the idle mode, the charging mode, or the audio mode. The adaptive current control may include the power supply subsystem 110 controlling a plurality of currents to regulate output currents within one or more maximum allowable power values based at least in part on the different operating conditions for the plurality of electronic devices when one or more electronic devices of the plurality of electronic devices is in one of the idle mode, the charging mode, or the audio mode while one or more other electronic devices of the plurality of electronic devices is in a different one of the idle mode, the charging mode, or the audio mode.

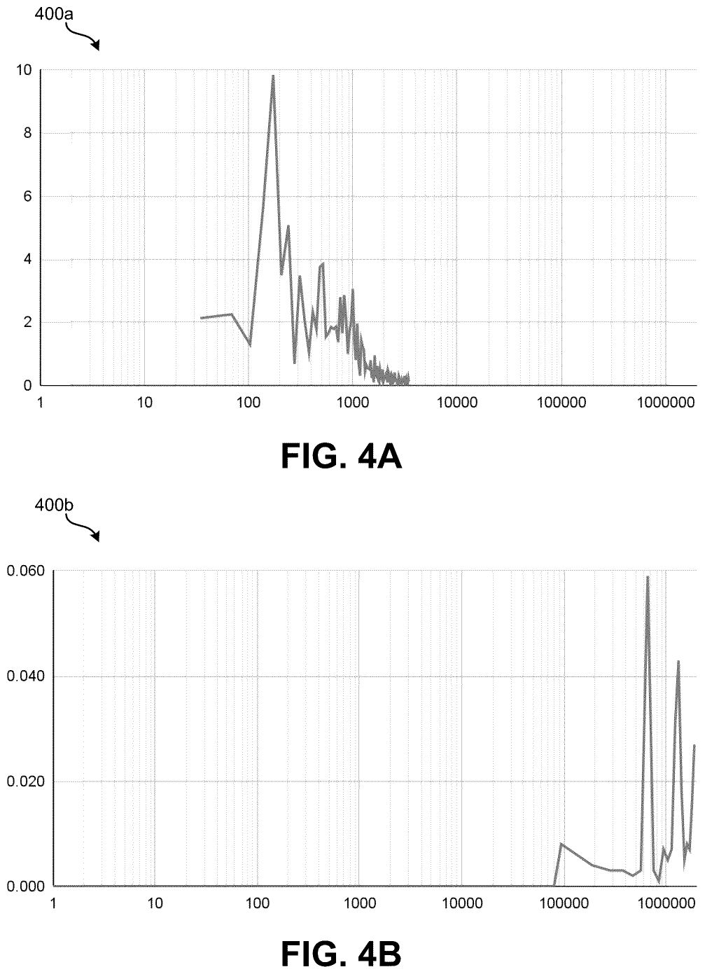

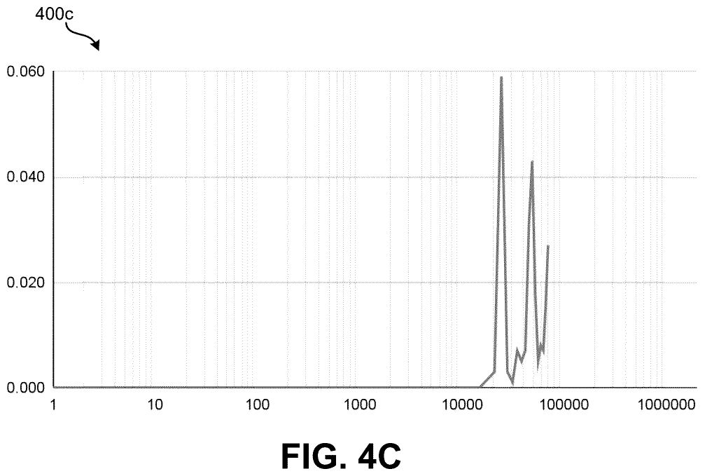

For added clarity, FIGS. 4A-4C show example plots 400 of AC components with different spectral content that is characteristic of three different operating conditions. For example, it can be assumed that the plots 400 represent the type of information that would be output by the FFT block 310, such that the frequency grouping and clustering block 320 would be able to discriminate among the three illustrated operating conditions. Each plot shows AC components magnitude (in milliamps) versus frequency. The first plot 400a represents spectral content for an illustrative audio active condition. The second plot 400b represents spectral content for an illustrative charging condition. The third plot 400c represents spectral content for an illustrative idle condition.

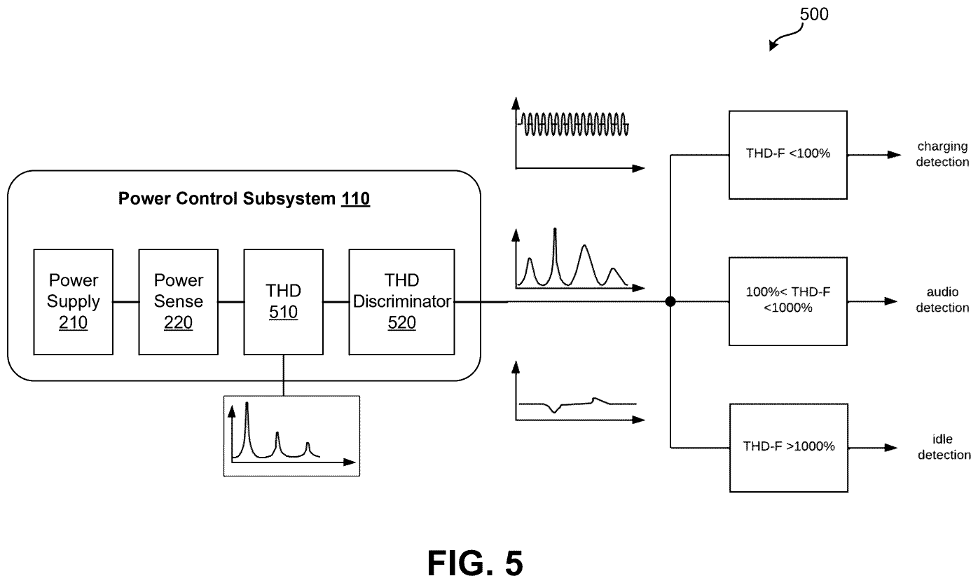

FIG. 5 shows a block diagram of an illustrative operating condition-adaptive power architecture 500 based at least in part on total harmonic distortion, according to some embodiments described herein. As in FIGS. 2A and 2B, the architecture 500 can include a power supply block 210 and a power sense block 220 (the adaptive control path, whether as feedback to the power supply block 210 or as including the C-A power optimizer 250, is not shown). As illustrated, the frequency domain analyzer 230 of FIGS. 2A and 2B is implemented in FIG. 5 as a total harmonic distortion (THD) block 510, and the discriminator 240 of FIGS. 2A and 2B is implemented in FIG. 5 as a THD discriminator block 520. Although embodiments are described with specific reference to THD, such embodiments can be similarly implemented using other related approaches, such as those listed above.

THD is generally a measure for quantifying the degree to which a system distorts the input signal, particularly in terms of the harmonic content of the signal. THD effectively quantifies the distortion that happens when a signal is passed through a system, resulting in the generation of harmonics, such as by computing a percentage of the sum of the powers of all harmonic frequencies with respect to the power of the fundamental frequency. Generally, a lower THD value indicates a cleaner signal with less distortion (i.e., the signal closely resembles a pure sine wave at the fundamental frequency). A high THD indicates that there is a significant amount of distortion, indicating that the signal contains a substantial amount of harmonics other than the fundamental frequency. For reasons described above, different operating conditions can manifest different THD values on the source voltage signal.

Some embodiments use THD-F and/or THD-R. THD-F represents the THD plus noise with respect to the fundamental. It is a measure of total harmonics in the presence of noise, excluding the fundamental frequency. Such a measurement can represent a signal's quality by focusing on the distortion and noise aspects without the dominating effect of the fundamental frequency. THD-F can be mathematically represented as follows:

$${THD}_{F} = \frac{\sqrt{{V}_{2}^{2} + {V}_{3}^{2} + {V}_{4}^{2} + …}}{{V}_{1}} ,$$

where V₁ is the RMS voltage of the fundamental frequency, and V₂, V₃, . . . are the RMS voltages of the second, third, etc. harmonics.

THD-R (or THD-RMS) represents the THD plus noise with respect to the total signal (i.e., the fundamental frequency is included in the calculation). THD-R essentially provides a ratio of the entire signal's harmonic distortion and noise to the total signal power. THD-R can be mathematically represented as follows:

$${THD}_{R} = \frac{\sqrt{{V}_{2}^{2} + {V}_{3}^{2} + {V}_{4}^{2} + …}}{\sqrt{{V}_{1}^{2} + {V}_{2}^{2} + {V}_{3}^{2} + …}} = \frac{{THD}_{F}}{\sqrt{1 + {THD}_{F}^{2}}} .$$

As described above, different operating conditions can cause the source voltage signal to have a different harmonic composition that impacts the THD. The following table illustrates THD test results for three operating conditions described above:

| Operating Condition | THD-F | THD-R |
|---|---|---|
| Idle | 1155% | 0.99% |
| Charging | 27% | 0.26% |
| Audio Active | 214% | 0.90% |

Several features are provided by embodiments described herein. One feature is that intelligent detection and adaptation approaches described herein can tend to reduce product power consumption. Embodiments can be implemented with internal and/or external power modules (e.g., internal power supplies, external power adapters, etc.). Rather than relying on command signals from other components of the product, embodiments described herein add the intelligence to the power system itself. This can yield related features, such as that the power system design can be decoupled from the product-side design, that multiple products and generations of products can share a same power system design without compatibility issues, and that the added intelligence can be added without increasing the cost of the product itself (while still providing power savings, brown-out prevention, etc.).

Another feature is that embodiments can maximize the product power savings at different operation conditions. For example, in the charging condition, significant power saving can yield significant reduction in the system cooling cost and avoid thermal throttling. Another feature is that the adaptive control described herein can be further optimized to a linear adaptive control relation between the power apparatus output voltage and system power consumption, so it can control the system operation at a high level of granularity. Another feature is that embodiments described herein can be added to external power supplies without changing the enclosure design, connector, wire types, etc., which can help to maintain compatibility with all on-shelf devices and to achieve power savings without user impact.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, several steps may be undertaken before, during, or after the above elements are considered. Accordingly, the above description should not be taken as limiting the scope of the invention.

What is claimed:

1. A system to control power to an electronic device with operating condition-aware power adaptation, the system comprising:
a power supply subsystem to output power to drive an electronic device, the power supply subsystem to drive the electronic device with a source voltage signal corresponding to a first output voltage;
a frequency domain analyzer coupled with the power supply subsystem to receive the source voltage signal that is provided to the electronic device, the frequency domain analyzer to output spectral content information characterizing the source voltage signal;
a discriminator coupled with the frequency domain analyzer and the power supply subsystem, the discriminator to:
determine, based at least in part on the spectral content information, an operating condition corresponding to the electronic device being driven by the source voltage signal; and
generate a control signal as a function of the determined operating condition to implement adaptive voltage control;
wherein:
the operating condition is selected from a group comprising an idle mode, a charging mode, and an audio mode;
the adaptive voltage control comprises the power supply subsystem optimizing the source voltage signal;
the optimizing comprises adjusting the source voltage signal to a second output voltage;
the second output voltage different from the first output voltage; and
the second output voltage is optimized for the determined operating condition in which the electronic is determined to be operating.

2. The system to control power to an electronic device with operating condition-aware power adaptation as recited in claim 1, wherein, when the operating condition corresponding to the electronic device is determined to be the idle mode, the second output voltage is adjusted to a lower voltage that is lower than the first output voltage.

3. The system to control power to an electronic device with operating condition-aware power adaptation as recited in claim 2, wherein the adaptive voltage control further comprises causing the adjusted source voltage signal to bypass an intermediate bus voltage regulator that is coupled with the power supply subsystem while driving the electronic device in the idle mode.

4. The system to control power to an electronic device with operating condition-aware power adaptation as recited in claim 1, wherein, when the operating condition corresponding to the electronic device is determined to be the charging mode, the second output voltage is adjusted to an intermediate voltage that is between a minimum voltage and a maximum voltage.

5. The system to control power to an electronic device with operating condition-aware power adaptation as recited in claim 4, wherein the adaptive voltage control further comprises causing the adjusted source voltage signal to bypass a charging bus voltage regulator that is coupled with the power supply subsystem while driving the electronic device in the charging mode.

6. The system to control power to an electronic device with operating condition-aware power adaptation as recited in claim 4, wherein:
the generating the control signal as a function of the determined operating condition is further to implement adaptive current control; and
the adaptive current control comprises the power supply subsystem controlling a current driving the electronic device to regulate the current output within its maximum allowable power and prevent the electronic device from brown-out caused by overcharging.

7. The system to control power to an electronic device with operating condition-aware power adaptation as recited in claim 6, wherein the controlling the current is in accordance with a droop current control profile.

8. The system to control power to an electronic device with operating condition-aware power adaptation as recited in claim 1, wherein, when the operating condition corresponding to the electronic device is determined to be the audio mode, the second output voltage is adjusted to a higher voltage that is higher than the first output voltage.

9. The system to control power to an electronic device with operating condition-aware power adaptation as recited in claim 8, wherein the second output voltage corresponds to a maximum voltage.

10. The system to control power to an electronic device with operating condition-aware power adaptation as recited in claim 8, wherein:
the generating the control signal as a function of the determined operating condition is further to implement adaptive current control; and
the adaptive current control comprises the power supply subsystem controlling a current driving the electronic device to regulate the current output within its maximum allowable power and prevent the electronic device from brown-out caused by audio peak power.

11. The system to control power to an electronic device with operating condition-aware power adaptation as recited in claim 10, wherein the controlling the current is in accordance with a droop current control profile.

12. The system to control power to an electronic device with operating condition-aware power adaptation as recited in claim 1, further comprising:
a power optimizer of the power supply subsystem that is condition-aware and coupled with the discriminator to generate the optimized source voltage signal based at least in part on the control signal and the source voltage signal.

13. The system to control power to an electronic device with operating condition-aware power adaptation as recited in claim 1, wherein a power supply block of the power supply subsystem is configured to generate the optimized source voltage signal based at least in part on the control signal.

14. The system to control power to an electronic device with operating condition-aware power adaptation as recited in claim 1, wherein the frequency domain analyzer outputs the spectral content information characterizing the source voltage signal based at least in part on a fast Fourier transform analysis of the source voltage signal.

15. The system to control power to an electronic device with operating condition-aware power adaptation as recited in claim 1, wherein the frequency domain analyzer outputs the spectral content information characterizing the source voltage signal based at least in part on total harmonic distortion analysis of the source voltage signal.

16. The system to control power to an electronic device with operating condition-aware power adaptation as recited in claim 1, wherein:
the power supply subsystem comprises a power supply block coupled with a power sense block; and
the frequency domain analyzer is coupled with an output of the power sense block to receive the source voltage signal.

17. The system to control power to an electronic device with operating condition-aware power adaptation as recited in claim 1, wherein the system corresponds to an internal power supply of the electronic device.

18. The system to control power to an electronic device with operating condition-aware power adaptation as recited in claim 1, wherein the system corresponds to an external power supply of the electronic device.

19. The system to control power to an electronic device with operating condition-aware power adaptation as recited in claim 1, wherein:
the system is configured to simultaneously drive a plurality of electronic devices with the adaptive voltage control and adaptive current control;
the adaptive voltage control comprises the power supply subsystem optimizing a plurality of source voltage signals based at least in part on different operating conditions for the plurality of electronic devices;
the adaptive current control comprises the power supply subsystem controlling a plurality of currents to regulate output currents within one or more maximum allowable power values based at least in part on the different operating conditions for the plurality of electronic devices; and
one or more electronic devices of the plurality of electronic devices is in one of the idle mode, the charging mode, or the audio mode while one or more other electronic devices of the plurality of electronic devices is in a different one of the idle mode, the charging mode, or the audio mode.

20. A method to control power to an electronic device with operating condition-aware power adaptation, the method comprising:
outputting power to drive an electronic device with a source voltage signal corresponding to a first output voltage;
receiving the source voltage signal that is provided to the electronic device, and outputting spectral content information characterizing the source voltage signal;
determining, based at least in part on the spectral content information, an operating condition corresponding to the electronic device being driven by the source voltage signal, wherein the operating condition is selected from a group comprising an idle mode, a charging mode, and an audio mode; and
generating a control signal as a function of the determined operating condition to implement adaptive voltage control, wherein:
implementing adaptive voltage control comprises optimizing the source voltage signal, wherein the optimizing comprising adjusting the source voltage signal to a second output voltage that is different from the first output voltage; and
the second output voltage is optimized for the determined operating condition in which the electronic is determined to be operating.
